(19) United States
(12) Patent Application Publication
(10) Pub. No.: US 2020/0112059 A1
(43) Pub. Date: Apr. 9, 2020

(54) Lithium bis(fluorosulfonyl)imide Salt and Uses Thereof

(71) Applicant: Arkema France, Colombes (FR)

(72) Inventors: Grégory Schmidt, Saint Andeol le Chateau (FR); Rémy Teissier, Francheville (FR); Philippe Bonnet, Lyon (FR)

(73) Assignee: Arkema France, Colombes (FR)

(21) Appl. No.: 16/096,531

(22) PCT Filed: Feb. 13, 2018
(86) PCT No.: PCT/FR2018/050339

§ 371 Date: Oct. 25, 2018

(30) Foreign Application Priority Data
Feb. 14, 2017 (FR) 1751183

(51) Int. Cl. H01M 10/0568; H01M 10/0525; C01B 21/086

(52) U.S. Cl. CPC H01M 10/0568; H01M 10/0525; C01P 2006/40; H01M 2300/0025; C01B 21/086

(57) ABSTRACT

A lithium bis(fluorosulfonyl)imide salt, wherein, after dissolving in water to form an aqueous solution, the aqueous solution has a pH of between 4 and 8, in particular at a temperature of 25° C., and the uses thereof in Li-ion batteries. Also, a lithium bis(fluorosulfonyl)imide salt, including a content of H+ ions of between 0.08 ppb and 0.80 ppm, between 0.08 ppb and 0.63 ppm or between 0.25 ppb and 2.53 ppb.

### FIELD OF THE INVENTION

The present invention relates to a lithium bis(fluorosulfonyl)imide salt with a specific content of protons H⁺.

The present invention also relates to various uses of said lithium bis(fluorosulfonyl)imide salt.

The development of higher-power batteries is required for the Li-ion battery market. This is done by increasing the nominal voltage of Li-ion batteries. To achieve the targeted voltages, high-purity electrolytes are required.

In the specific field of Li-ion batteries, the salt that is currently the most widely used is LiPF₆. This salt has many drawbacks, such as limited thermal stability, sensitivity to hydrolysis and thus poorer safety of the battery.

Novel lithium salts of sulfonylimide type have recently been developed in an attempt to improve the performance of rechargeable batteries. Mention may be made of LiTFSI (lithium bis(trifluoromethanesulfonyl)imide) and LiFSI (lithium bis(fluorosulfonyl)imide). These salts show little or no spontaneous decomposition, and are more stable to hydrolysis than LiPF₆. However, LiTFSI has the drawback of being corrosive toward aluminum current collectors.

However, there is a need for novel salts with improved electronic performance and/or a longer service life in Li-ion batteries.

There is also a need for novel salts that can be used at high cut-off voltages.

### DESCRIPTION OF THE INVENTION

The present invention relates to a lithium bis(fluorosulfonyl)imide salt, characterized in that, after dissolving in water to form an aqueous solution, said aqueous solution has a pH of between 4 and 8, in particular at a temperature of 25° C.

According to a preferred embodiment, the LiFSI salt is such that, after dissolving in water to form an aqueous solution, said aqueous solution has a pH, for example, of between 4.1 and 8, between 4.2 and 8, between 4.3 and 8, between 4.4 and 8, between 4.5 and 8, between 4.6 and 8, between 4.7 and 8, between 4.8 and 8, between 4.9 and 8, between 5 and 8, between 5.1 and 8, between 5.2 and 8, between 5.3 and 8, between 5.4 and 8, between 5.5 and 8, between 5.6 and 8, between 5.7 and 8, between 5.8 and 8, between 5.9 and 8, between 6 and 8, between 6.1 and 8, between 6.2 and 8, between 6.3 and 8, between 6.4 and 8, between 6.5 and 8, between 6.6 and 8, between 6.7 and 8, between 6.8 and 8, between 6.9 and 8, between 7 and 8, between 4 and 7.5, between 4.1 and 7.5, between 4.2 and 7.5, between 4.3 and 7.5, between 4.4 and 7.5, between 4.5 and 7.5, between 4.6 and 7.5, between 4.7 and 7.5, between 4.8 and 7.5, between 4.9 and 7.5, between 5 and 7.5, between 5.1 and 7.5, between 5.2 and 7.5, between 5.3 and 7.5, between 5.4 and 7.5, between 5.5 and 7.5, between 5.6 and 7.5, between 5.7 and 7.5, between 5.8 and 7.5, between 5.9 and 7.5, between 6 and 7.5, between 6.1 and 7.5, between 6.2 and 7.5, between 6.3 and 7.5, between 6.4 and 7.5 or between 6.5 and 7.5. Preferably, the LiFSI salt according to the invention is such that, after dissolving in water to form an aqueous solution, said aqueous solution has a pH of between 6 and 8, preferably between 6.5 and 8, and in particular between 6.5 and 7.5.

In the context of the invention, the terms “lithium salt of bis(fluorosulfonyl)imide”, “lithium bis(sulfonyl)imide”, “LiFSI”, “LiN(FSO₂)₂”, “lithium bis(sulfonyl)imide” and “lithium bis(fluorosulfonyl)imide” are used equivalently.

Typically, pH is defined as the negative logarithm of the hydrogen ion activity, according to the following formula:

pH=−log₁₀[H⁺]

The pH of a solution may be measured via any method known to those skilled in the art. The pH may be measured, for example, using a glass electrode, the potential of which may vary as a function of the concentration of hydrogen ions according to the Nernst equation. This potential may be measured relative to a reference electrode using a high-impedance potentiometer, commonly known as a pH-meter. An example of a pH-meter that may be used is the pHM210 model from Radiometer.

The pH of the LiFSI solution may be measured using a pH-meter, which is in particular calibrated beforehand using three buffer solutions (pH=4.0, 7.0 and 10.0). The LiFSI salt may dissolved in water (said water preferably having a pH of 7.45±0.5) to obtain an LiFSI mass concentration of 0.125 g/mL. The aqueous solution may be stirred during the pH measurement.

According to one embodiment, the LiFSI concentration in the aqueous solution according to the invention is between 0.050 and 0.250 g/mL, preferably between 0.080 and 0.200 g/mL, preferentially between 0.1 and 0.2, and in particular the concentration is 0.125 g/mL.

According to one embodiment, the abovementioned lithium bis(fluorosulfonyl)imide salt comprises a content of H⁺ ions of between 0.08 ppb and 0.80 ppm, between 0.08 ppb and 0.63 ppm, between 0.08 ppb and 0.50 ppm, between 0.08 ppb and 0.40 ppm, between 0.08 ppb and 0.32 ppm, between 0.08 ppb and 0.25 ppm, between 0.08 ppb and 0.20 ppm, between 0.08 ppb and 0.16 ppm, between 0.08 ppb and 0.13 ppm, between 0.08 ppb and 0.10 ppm, between 0.08 ppb and 0.08 ppm, between 0.08 ppb and 0.06 ppm, between 0.08 ppb and 0.05 ppm, between 0.08 ppb and 0.04 ppm, between 0.08 ppb and 0.032 ppm, between 0.08 ppb and 0.025 ppm, between 0.08 ppb and 0.020 ppm, between 0.08 ppb and 0.016 ppm, between 0.08 ppb and 0.013 ppm, between 0.08 ppb and 10 ppb, between 0.08 ppb and 8 ppb, between 0.08 ppb and 6.35 ppb, between 0.08 ppb and 5.05 ppb, between 0.08 ppb and 4 ppb, between 0.08 ppb and 3.18 ppb, between 0.08 ppb and 2.53 ppb, between 0.08 ppb and 2.01 ppb, between 0.08 ppb and 1.59 ppb, between 0.08 ppb and 1.27 ppb, between 0.08 ppb and 1.01 ppb, between 0.25 ppb and 0.8 ppm, between 0.25 ppb and 0.63 ppm, between 0.25 ppb and 0.50 ppm, between 0.25 ppb and 0.40 ppm, between 0.25 ppb and 0.32 ppm, between 0.25 ppb and 0.25 ppm, between 0.25 ppb and 0.20 ppm, between 0.25 ppb and 0.16 ppm, between 0.25 ppb and 0.13 ppm, between 0.25 ppb and 0.10 ppm, between 0.25 ppb and 0.08 ppm, between 0.25 ppb and 0.06 ppm, between 0.25 ppb and 0.05 ppm, between 0.25 ppb and 0.04 ppm, between 0.25 ppb and 0.032 ppm, between 0.25 ppb and 0.025 ppm, between 0.25 ppb and 0.020 ppm, between 0.25 ppb and 0.016 ppm, between 0.25 ppb and 0.013 ppm, between 0.25 ppb and 10 ppb, between 0.25 ppb and 8 ppb, between 0.25 ppb and 6.35 ppb, between 0.25 ppb and 5.05 ppb, between 0.25 ppb and 4 ppb, between 0.25 ppb and 3.18 ppb or between 0.25 ppb and 2.53 ppb.

In the context of the invention, the term “ppm” corresponds to “parts per million” and is understood as ppm on a weight basis.

In the context of the invention, the term “ppb” corresponds to “parts per billion” and is understood as ppb on a weight basis.

In the context of the invention, the expression “salt with an H⁺ ion content equal to 8 ppm by weight” means, for example, a salt with an H⁺ ion content equal to 8 ppm by weight relative to the total weight of said salt.

The present invention also relates to a lithium bis(fluorosulfonyl)imide salt comprising a content of H⁺ ions of between 0.08 ppb and 0.80 ppm, between 0.08 ppb and 0.63 ppm, between 0.08 ppb and 0.50 ppm, between 0.08 ppb and 0.40 ppm, between 0.08 ppb and 0.32 ppm, between 0.08 ppb and 0.25 ppm, between 0.08 ppb and 0.20 ppm, between 0.08 ppb and 0.16 ppm, between 0.08 ppb and 0.13 ppm, between 0.08 ppb and 0.10 ppm, between 0.08 ppb and 0.08 ppm, between 0.08 ppb and 0.06 ppm, between 0.08 ppb and 0.05 ppm, between 0.08 ppb and 0.04 ppm, between 0.08 ppb and 0.032 ppm, between 0.08 ppb and 0.025 ppm, between 0.08 ppb and 0.020 ppm, between 0.08 ppb and 0.016 ppm, between 0.08 ppb and 0.013 ppm, between 0.08 ppb and 10 ppb, between 0.08 ppb and 8 ppb, between 0.08 ppb and 6.35 ppb, between 0.08 ppb and 5.05 ppb, between 0.08 ppb and 4 ppb, between 0.08 ppb and 3.18 ppb, between 0.08 ppb and 2.53 ppb, between 0.08 ppb and 2.01 ppb, between 0.08 ppb and 1.59 ppb, between 0.08 ppb and 1.27 ppb, between 0.08 ppb and 1.01 ppb, between 0.25 ppb and 0.8 ppm, between 0.25 ppb and 0.63 ppm, between 0.25 ppb and 0.50 ppm, between 0.25 ppb and 0.40 ppm, between 0.25 ppb and 0.32 ppm, between 0.25 ppb and 0.25 ppm, between 0.25 ppb and 0.20 ppm, between 0.25 ppb and 0.16 ppm, between 0.25 ppb and 0.13 ppm, between 0.25 ppb and 0.10 ppm, between 0.25 ppb and 0.08 ppm, between 0.25 ppb and 0.06 ppm, between 0.25 ppb and 0.05 ppm, between 0.25 ppb and 0.04 ppm, between 0.25 ppb and 0.032 ppm, between 0.25 ppb and 0.025 ppm, between 0.25 ppb and 0.020 ppm, between 0.25 ppb and 0.016 ppm, between 0.25 ppb and 0.013 ppm, between 0.25 ppb and 10 ppb, between 0.25 ppb and 8 ppb, between 0.25 ppb and 6.35 ppb, between 0.25 ppb and 5.05 ppb, between 0.25 ppb and 4 ppb, between 0.25 ppb and 3.18 ppb or between 0.25 ppb and 2.53 ppb.

The determination of the content of protons H⁺ in the lithium bis(fluorosulfonyl)imide salt is preferably performed by pH-metry, in particular according to the method mentioned previously.

The Applicant has discovered that the use of the LiFSI salt according to the invention in an Li-ion battery electrolyte advantageously makes it possible to have a low residual current at a cut-off voltage of, for example, 4.2 V or 4.4 V. This residual current reflects the spurious reactions that take place in an Li-ion battery during its use. These spurious reactions consume electrons and thus reduce the autonomy of Li-ion batteries during their use. Moreover, these spurious reactions also have a strong impact on the battery safety, since such reactions may create chain reactions that may cause a runaway reaction and explosion of the Li-ion battery.

Thus, the use of the LiFSI salt according to the invention in an Li-ion battery advantageously makes it possible to improve the service life of an Li-ion battery and/or the electronic performance of an Li-ion battery, and/or the safety of said battery, in particular at a high cut-off voltage, for instance 4.4 V.

The use of the LiFSI salt according to the invention in an Li-ion battery advantageously makes it possible to reach a high cut-off voltage, especially greater than or equal to 4.4 V.

In the context of the invention, and unless otherwise mentioned, the term “cut-off voltage” means the upper voltage limit of a battery considered as being totally charged. The cut-off voltage is usually chosen so as to obtain the maximum battery capacity.

The present invention also relates to the use of the lithium bis(fluorosulfonyl)imide salt in an Li-ion battery.

The present invention also relates to the use of the lithium bis(fluorosulfonyl)imide salt in an Li-ion battery functioning at a cut-off voltage of greater than or equal to 4.2 V, preferably greater than or equal to 4.4 V.

The present invention also relates to the use of the lithium bis(fluorosulfonyl)imide salt in an electrolyte, especially in an Li-ion battery electrolyte.

The present invention also relates to an electrolyte composition comprising the lithium bis(fluorosulfonyl)imide salt as defined according to the invention, and an organic solvent.

Examples of organic solvents include ethers such as ethylene glycol dimethyl ether (1,2-dimethoxyethane), ethylene glycol diethyl ether, tetrahydrofuran, 2-methyltetrahydrofuran, 2,6-dimethyltetrahydrofuran, tetrahydropyran, a crown ether, triethylene glycol dimethyl ether, tetraethylene glycol dimethyl ether, 1,4-dioxane and 1,3-dioxolane; carbonic acid esters such as dimethyl carbonate, methyl ethyl carbonate, diethyl carbonate, diphenyl carbonate and methyl phenyl carbonate; cyclic carbonate esters such as ethylene carbonate, propylene carbonate, ethylene 2,3-dimethyl carbonate, butylene carbonate, vinylene carbonate and ethylene 2-vinyl carbonate; aliphatic carboxylic acid esters such as methyl formate, methyl acetate, methyl propionate, ethyl acetate, propyl acetate, butyl acetate and amyl acetate; aromatic carboxylic acid esters such as methyl benzoate and ethyl benzoate; carboxylic acid esters such as γ-butyrolactone, γ-valerolactone and 5-valerolactone; phosphoric acid esters such as trimethyl phosphate, ethyl dimethyl phosphate, diethyl methyl phosphate and triethyl phosphate; nitriles such as acetonitrile, propionitrile, methoxypropionitrile, glutaronitrile, adiponitrile, 2-methylglutaronitrile, valeronitrile, butyronitrile and isobutyronitrile; amides such as N-methylformamide, N-ethylformamide, N, N-dimethylformamide, N, N-dimethylacetamide, N-methylpyrrolidinone, N-methylpyrrolidone and N-vinylpyrrolidone; sulfur-based compounds such as dimethyl sulfone, methyl ethyl sulfone, diethyl sulfone, sulfolane, 3-methylsulfolane and 2,4-dimethylsulfolane; alcohols such as ethylene glycol, propylene glycol, ethylene glycol monomethyl ether and ethylene glycol monoethyl ether; sulfoxides such as dimethyl sulfoxide, methyl ethyl sulfoxide and diethyl sulfoxide; aromatic nitriles such as benzonitrile and tolunitrile; nitromethane; 1,3-dimethyl-2-imidazolidinone; 1,3-dimethyl-3,4,5,6-tetrahydro-2(1,H)-pyrimidinone; 3-methyl-2-oxazolidinone. These solvents may be used alone or in combination.

Carbonic acid esters, aliphatic carboxylic acid esters, carboxylic acid esters and ethers are preferred, and carbonic acid esters are even more preferred. In particular, the organic solvent is the ethylene carbonate/methyl ethyl carbonate mixture, in particular in a 3/7 volume ratio.

The concentration of LiFSI salt according to the invention may range between 0.1% and 15% and preferably between 1% and 10% by weight relative to the total weight of the electrolyte composition.

According to one embodiment, the electrolyte composition may comprise one or more additives. Mention may be made, for example, of fluoroethylene carbonate, vinylene carbonate, ionic liquids, anhydrides, for instance succinic anhydride, and mixtures thereof.

The content of additives in the electrolyte composition according to the invention may range between 0.1% and 10% and preferably between 1% and 5% by weight relative to the total weight of the electrolyte composition.

The present invention also relates to the use of said lithium bis(fluorosulfonyl)imide salt or of the electrolyte composition containing same, in Li-ion batteries, in particular in Li-ion batteries of mobile devices, for example cell phones or laptop computers, electric vehicles, or renewable power storage devices, for example photovoltaic or wind power devices.

The present patent application relates to the use of the lithium bis(fluorosulfonyl)imide salt according to the invention for improving the service life of an Li-ion battery and/or the electronic performance of an Li-ion battery, and/or the safety of said battery, in particular at a high cut-off voltage, for instance 4.4 V.

Preferably, the invention relates to the use of the lithium bis(fluorosulfonyl)imide salt according to the invention for reducing the residual current during the application of a cut-off voltage, for example of 4.2 volts or 4.4 volts.

The lithium bis(fluorosulfonyl)imide salt according to the invention, having a specific content of H⁺ ions or a specific pH in aqueous solution, may be obtained by performing a step of adjusting the pH of a lithium bis(fluorosulfonyl)imide salt in water prepared initially via any process known in the prior art.

The present invention also relates to a process for preparing an abovementioned lithium bis(fluorosulfonyl)imide salt, comprising:
i) a step of preparing a lithium bis(fluorosulfonyl)imide salt; and
ii) a step of adjusting the pH,
   to obtain a lithium bis(fluorosulfonyl)imide salt forming, after dissolution in water, an aqueous solution with a pH of between 4 and 8, in particular at a temperature of 25° C.

The present invention also relates to a process for preparing an abovementioned lithium bis(fluorosulfonyl)imide salt, comprising:
i) a step of preparing a lithium bis(fluorosulfonyl)imide salt; and
ii) a step of adjusting the pH,
   to obtain a lithium bis(fluorosulfonyl)imide salt, comprising a content of H⁺ ions of between 0.08 ppb and 0.80 ppm.

The step of adjusting the pH may consist of washing one or more times with water, especially deionized water, or of adding a basic aqueous solution.

The preparation process may comprise subsequent steps of extraction of the lithium bis(fluorosulfonyl)imide salt obtained on conclusion of step ii) in organic phase (for example by adding an organic solvent such as butyl acetate), concentration, for example at a temperature below 60° C., crystallization, etc.

All the embodiments described above may be combined with each other. The examples that follow illustrate the invention without, however, limiting it.

### EXAMPLES

Chronoamperometry tests were performed. To do this, CR2032 button cells were manufactured equipped with an aluminum sheet 20 mm in diameter as working electrode, a lithium metal pellet 8 mm in diameter as reference electrode and a glass fiber separator 18 mm in diameter soaked with 12 drops (0.6 mL) of a 1 mol/L LiFSI solution in a solvent mixture composed of ethylene carbonate and methyl ethyl carbonate (CAS=623-53-0) in a 3/7 volume ratio. Next, a voltage was applied to the terminals of the button cell and the current generated was measured and recorded.

### Example 1: Chronoamperometry Study at a Cut-Off Voltage of 4.2 Volts

Chronoamperometry measurements were taken in a system with an aluminum electrode as working electrode and lithium metal as reference electrode.

pH measurement: The pH of the LiFSI solutions is measured using a pH-meter (pHM210 model from Radiometer) which is calibrated beforehand using three buffer solutions (pH=4.0, 7.0 and 10.0). The LiFSI salt was dissolved in an amount of water (having a pH of 7.45±0.5) to obtain an LiFSI mass concentration of 0.125 g/mL. The aqueous solution is stirred during the pH measurement.

The LiFSI salt of solution No. 3 was obtained according to the process described in Abouimrane et al. “Liquid electrolyte based on lithium bis-fluorosulfonyl imide salt: Al corrosion studies and lithium ion battery investigation”, Journal of Power Sources 189 (2009), pages 693-696 (paragraph 3. Results). The LiFSI salts of solutions No. 1 and No. 2 were obtained from the LiFSI salt prepared according to the process described in the abovementioned article by Abouimrane et al., followed by a step of adjusting the pH. Solutions 1 to 3 below were prepared and their pH was measured according to the method mentioned above:

| | LiFSI solution | | |
|---|---|---|---|
| | No. 1 | No. 2 | No. 3 |
| pH (at 25° C.) | 7.29 | 6.79 | 2.27 |

Preparation of the Electrolytes:

To perform the chronoamperometry tests, various Li-ion battery electrolytes were prepared starting with LiFSI solutions No. 1 to No. 3 (cf. above table).

Three electrolytes were prepared by dissolving an LiFSI salt (No. 1 to No. 3) in a solvent mixture composed of ethylene carbonate and methyl ethyl carbonate (CAS=623-53-0) in a 3/7 volume ratio, to obtain solutions with an LiFSI content of 1 mol/L:

| | Electrolyte | | |
|---|---|---|---|
| | E No. 1 | E No. 2 | E No. 3 |
| | (invention) | (invention) | (comparative) |
| | LiFSI solution | | |
| | No. 1 | No. 2 | No. 3 |
| pH (at 25° C.) | 7.29 | 6.79 | 2.27 |

Chronoamperometry

The chronoamperometry test was performed at 25° C. by applying a constant cut-off voltage (4.2 volts) and the current obtained was observed. After 5 hours, the residual current value was measured and retranscribed in the following table. This residual current is indicative of the side reactions that may take place during the functioning of an Li-ion battery.

pH

| | 2.27 | 7.29 |
|---|---|---|
| I at 4.2 V | 31 | 14.4 |
| (t = 5 H) | | |

The results show that the electrolyte E No. 3 (LiFSI: pH=2.27) leads to a residual current that is twice as high as that for the electrolyte E No. 1 (LiFSI: pH=7.29) after 5 hours of functioning (i.e. after the formation of the passivation layers on the aluminum electrode). Now, this current is directly connected to the service life of the Li-ion battery. Specifically, each electron consumed in a spurious reaction no longer participates in the capacity or autonomy of the battery.

Thus, the use of an LiFSI salt according to the invention (having a pH of 7.29 after dissolution in water) leads to a lower residual current, and as a result to a better service life of the Li-ion battery, than with an LiFSI salt with a pH of 2.27 after dissolution in water.

### Example 2: Chronoamperometry Study at 4.4 Volts

An experiment similar to that of example 2 was performed, but at a cut-off voltage of 4.4 V.

After 5 hours, the residual current value was measured and retranscribed in the following table.

| | pH | | |
|---|---|---|---|
| | 2.27 | 6.79 | 7.29 |
| I at 4.4 V | 401 | 203 | 130 |
| (t = 5 H) | | | |

The results show that the electrolyte E No. 3 (LiFSI: pH=2:27) leads to a residual current that is three times as high as that for the electrolyte E No. 1 (LiFSI: pH=7.29) after 5 hours of functioning (i.e. after the formation of the passivation layers on the aluminum electrode).

Thus, the use of an LiFSI salt according to the invention (having a pH of 7.29 after dissolution in water) leads to a lower residual current, and as a result to a better service life of the Li-ion battery, than with an LiFSI salt with a pH of 2.27.

Similar results are obtained with an LiFSI having a pH of 6.79 after dissolution in water relative to that with a pH of 2.27.

1. A lithium bis(fluorosulfonyl)imide salt, wherein after dissolving in water to form an aqueous solution, said aqueous solution has a pH of between 4 and 8 at a temperature of 25° C.

2. The lithium bis(fluorosulfonyl)imide salt as claimed in claim 1, wherein after dissolving in water to form an aqueous solution, said aqueous solution has a pH of between 4.1 and 8.

3. The lithium bis(fluorosulfonyl)imide salt as claimed in claim 1, wherein the concentration of said salt in the aqueous solution is between 0.050 and 0.250 g/mL.

4. The lithium bis(fluorosulfonyl)imide salt as claimed in claim 1, wherein it comprises a content of H⁺ ions of between 0.08 ppb and 0.80 ppm.

5. A lithium bis(fluorosulfonyl)imide salt comprising a content of H⁺ ions of between 0.08 ppb and 0.80 ppm.

6. A Li-ion battery comprising a lithium bis(fluorosulfonyl)imide salt as claimed in claim 1.

7. The Li-ion battery as claimed in claim 6, in an Li-ion battery functioning at a cut-off voltage of greater than or equal to 4.2 V, preferably greater than or equal to 4.4 V.

8. An electrolyte composition comprising a lithium bis(fluorosulfonyl)imide salt as claimed in claim 1, and an organic solvent.

9. A method of improving the service life of an Li-ion battery and/or the electronic performance of an Li-ion battery, the method comprising using a lithium bis(fluorosulfonyl)imide salt as claimed in claim 1 in an Li-ion battery.
